(19) United States
(12) Patent Application Publication
(10) Pub. No.: US 2019/0248580 A1
(43) Pub. Date: Aug. 15, 2019

(54) GARBAGE CAN SECURING ASSEMBLY

(71) Applicant: Philip Doherty, Queens, NY (US)

(72) Inventor: Philip Doherty, Queens, NY (US)

(21) Appl. No.: 15/897,898

(22) Filed: Feb. 15, 2018

(51) Int. Cl. B65F 1/14; F16B 45/04

(52) U.S. Cl. CPC B65F 1/141; B65F 2210/18; F16B 45/04

(57) ABSTRACT

A garbage can securing assembly for securing a garbage can to a wall or the like includes a pair of brackets. Each of the brackets may be attached to a vertical support surface and each of the brackets has a receiving space therein. The receiving space in each of the brackets insertably receives a handle of a garbage can. A pair of pins is provided and each of the pins removably engages an associated one of the brackets. Moreover, each of the pins retains the garbage can in the brackets thereby inhibiting the garbage can from being tipped.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to securing devices and more particularly pertains to a new securing device for securing a garbage can to a wall.

### BRIEF SUMMARY OF THE INVENTION

An embodiment of the disclosure meets the needs presented above by generally comprising a pair of brackets. Each of the brackets may be attached to a vertical support surface and each of the brackets has a receiving space therein. The receiving space in each of the brackets insertably receives a handle of a garbage can. A pair of pins is provided and each of the pins removably engages an associated one of the brackets. Moreover, each of the pins retains the garbage can in the brackets thereby inhibiting the garbage can from being tipped.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a garbage can securing assembly according to an embodiment of the disclosure.

FIG. 2 is a front view of an embodiment of the disclosure.

FIG. 3 is a perspective in-use view of an embodiment of the disclosure.

### DETAILED DESCRIPTION OF THE INVENTION

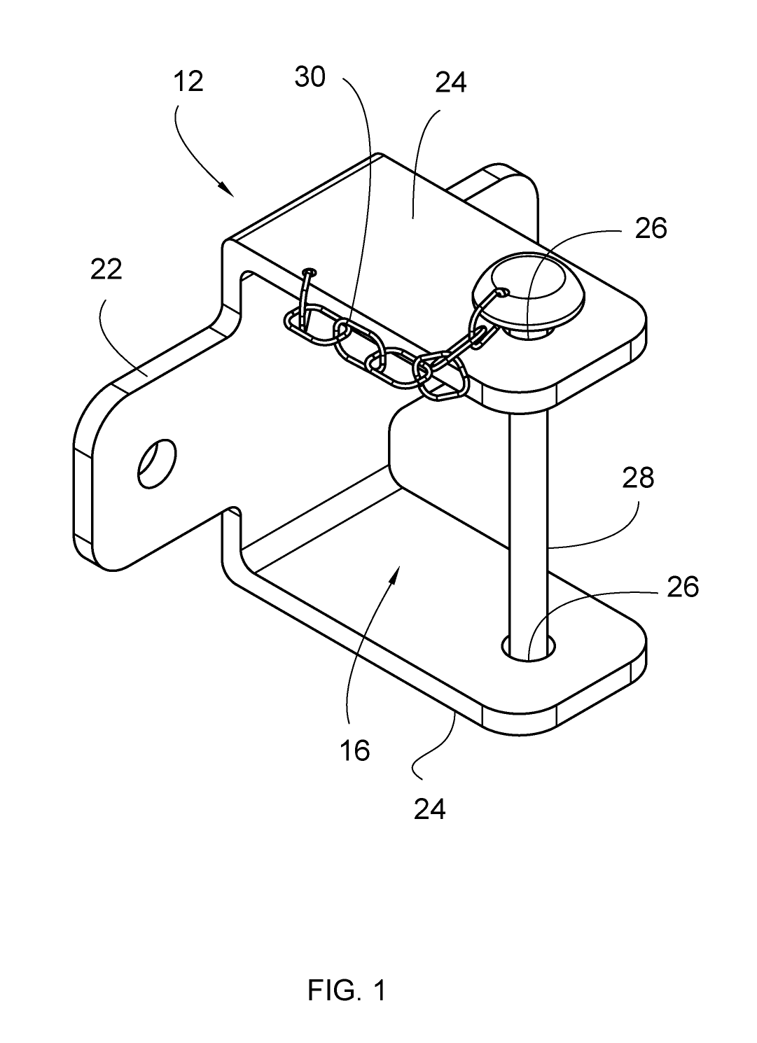

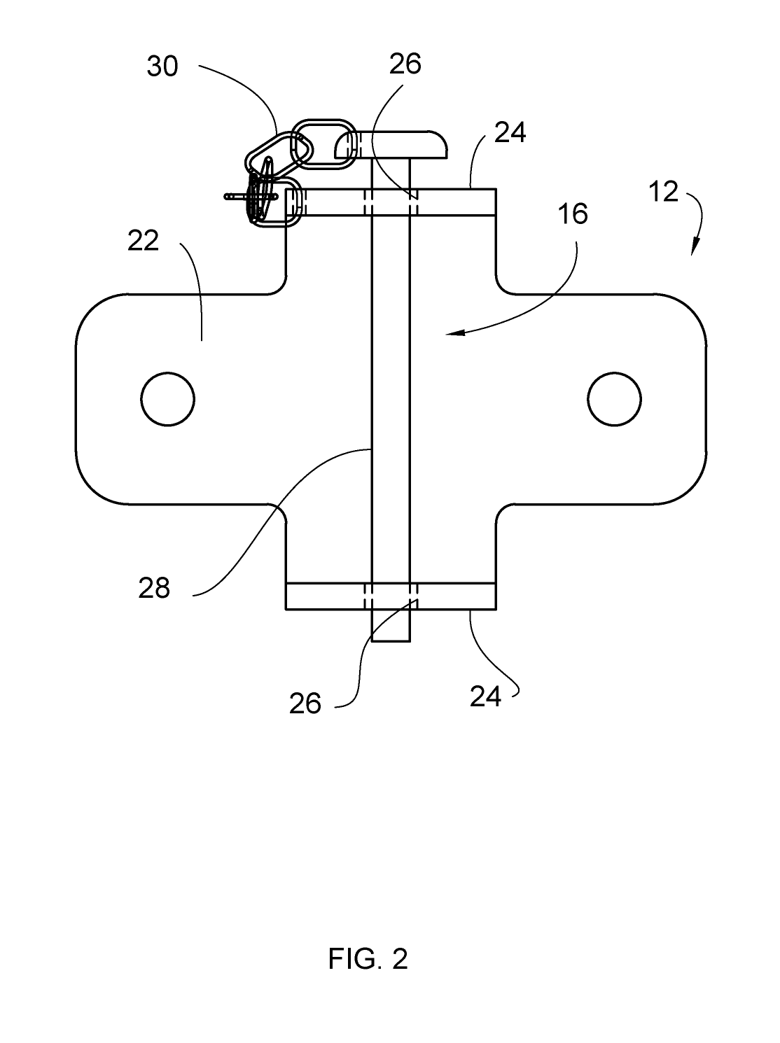

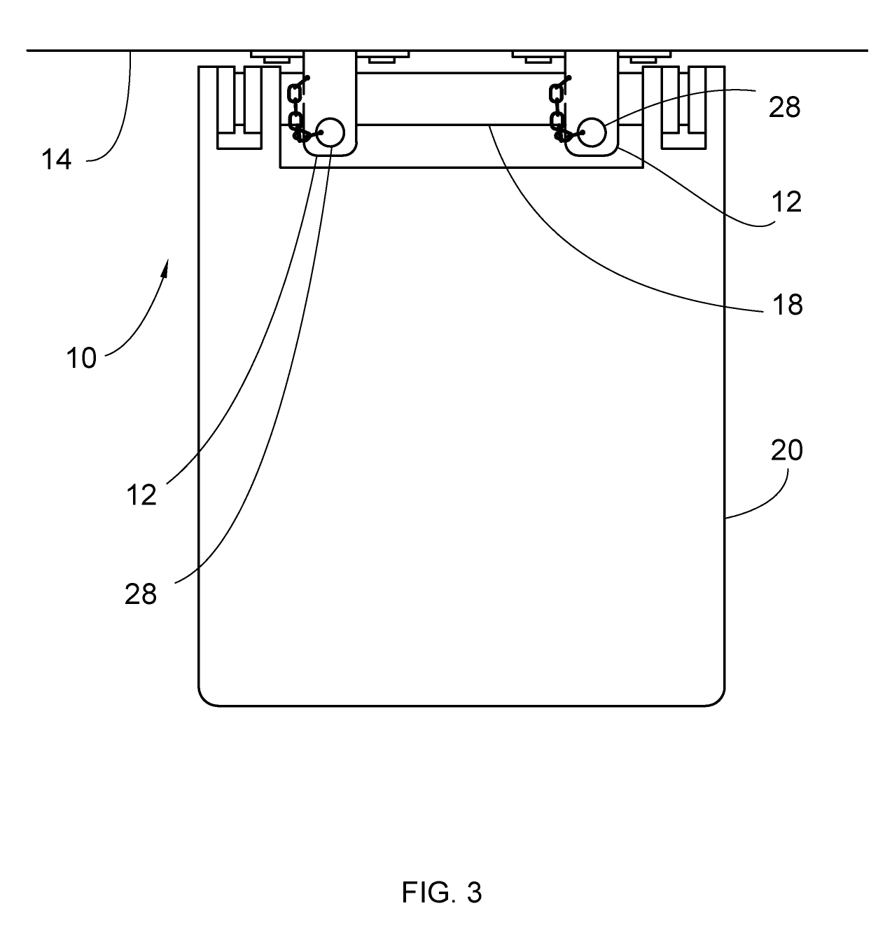

With reference now to the drawings, and in particular to FIGS. 1 through 3 thereof, a new securing device embodying the principles and concepts of an embodiment of the disclosure and generally designated by the reference numeral 10 will be described.

As best illustrated in FIGS. 1 through 3, the garbage can securing assembly 10 generally comprises a pair of brackets 12 and each of the brackets 12 may be attached to a vertical support surface 14. The vertical support surface 14 may be an exterior wall of a building or the like. Each of the brackets 12 has a receiving space 16 therein for insertably receiving a handle 18 of a garbage can 20. The garbage can 20 may be a wheeled garbage can 20 commonly used by commercial waste collection companies.

Each of the brackets 12 has a central panel 22 and a pair of outward panels 24 each extending away from the central panel 22 and each of the outward panels 24 is oriented perpendicular to the central panel 22. The outward panels 24 are spaced apart from each other on the central panel 22 to define the receiving space 16 extending between the outward panels 24. The central panel 22 corresponding to each of the brackets 12 abuts the vertical support surface 14 having the outward panels 24 corresponding to each of the brackets 12 being horizontally oriented.

Each of the outward panels 24 has an aperture 26 extending therethrough and the aperture 26 in each of the outward panels 24 is aligned with each other. Additionally, the aperture 26 in each of the outward panels 24 is spaced from the central panel 22. A pair of fasteners, such as bolts or the like, may extend the central panel 22 corresponding to each bracket and engage the vertical support surface 14 to couple each bracket to the vertical support surface 14.

A pair of pins 28 is provided and each of the pins 28 removably engages an associated one of the brackets 12 to retain the garbage can 20 in the brackets 12. In this way the brackets 12 and the pins 28 inhibit the garbage can 20 from being tipped. Each of the pins 28 extends through the aperture 26 in each of the outward panels 24 of the associated bracket. Each of the pins 28 includes a line 30 that is attached between the pin and the associated bracket such that each of the pins 28 is retained with the associated bracket. The line 30 may be a chain, cable and any other break resistant line 30.

In use, each of the brackets 12 is mounted to the vertical support surface 14 such that the outward panels 24 on each of the brackets 12 are horizontally oriented. Additionally, the brackets 12 are spaced apart from each other a distance that is less than an overall length of the handle 18 on the garbage can 20. The handle 18 of the garbage can 20 is positioned in the receiving space 16 in each bracket and each of the pins 28 is engaged to the brackets 12. In this way the brackets 12 and the pins 28 inhibit the garbage can 20 from being tipped over by wind, animals and other tipping forces thereby reducing the likelihood that the garbage can 20 will spill.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A garbage can securing assembly comprising:
a garbage can having a horizontally oriented handle;
a pair of brackets, each of said brackets being configured to be attached to a vertical support surface, each of said brackets having a receiving space therein, said receiving space of each said bracket having an open vertical face and open lateral ends wherein said receiving space in each of said brackets insertably receives the horizontally oriented handle of the garbage can inserted into said receiving space of each bracket in a horizontal direction such that the handle of the garbage can extends fully through said receiving space of both said brackets, each of said brackets having a central panel and a pair of outward panels each extending away from said central panel, each of said outward panels being oriented perpendicular to said central panel; and
a pair of pins, each of said pins removably engaging an associated one of said brackets wherein each of said pins retains the handle of the garbage can in said receiving space of each of said brackets thereby inhibiting the garbage can from being tipped.

2. (canceled)

3. The assembly according to claim 1, wherein said outward panels are spaced apart from each other on said central panel to define said receiving space extending between said outward panels, said central panel corresponding to each of said brackets having said outward panels corresponding to each of said brackets being horizontally oriented wherein said central panel corresponding to each of said brackets is configured for abutting the vertical support surface.

4. The assembly according to claim 1, wherein each of said outward panels has an aperture extending therethrough, said aperture in each of said outward panels being aligned with each other, said aperture in each of said outward panels being spaced from said central panel.

5. The assembly according to claim 4, wherein each of said pins extends through said aperture in each of said outward panels of said associated bracket.

6. A garbage can securing assembly comprising:
a garbage can having a horizontally oriented handle;
a pair of brackets, each of said brackets being configured to be attached to a vertical support surface, each of said brackets having a receiving space therein, said receiving space of each said bracket having open lateral ends wherein said receiving space in each of said brackets insertably a receives the horizontally oriented handle of the garbage can inserted into said receiving space of each bracket in a horizontal direction such that the handle of the garbage can extends fully through said receiving space of both said brackets, each of said brackets having a central panel and a pair of outward panels each extending away from said central panel, each of said outward panels being oriented perpendicular to said central panel, said outward panels being spaced apart from each other on said central panel to define said receiving space extending between said outward panels, said central panel corresponding to each of said brackets abutting the vertical support surface having said outward panels corresponding to each of said brackets being horizontally oriented, each of said outward panels having an aperture extending therethrough, said aperture in each of said outward panels being aligned with each other, said aperture in each of said outward panels being spaced from said central panel; and
a pair of pins, each of said pins removably engaging an associated one of said brackets wherein each of said pins retains the handle of the garbage can in said receiving space of each of said brackets thereby inhibiting the garbage can from being tipped, each of said pins extending through said aperture in each of said outward panels of said associated bracket.
